(19) United States
(12) Patent Application Publication
(10) Pub. No.: US 2026/0233335 A1
(43) Pub. Date: Aug. 13, 2026

(54) LASER SOLDERING BY PULSED LASER

(71) Applicant: DR Laser Singapore Pte Ltd., Singapore (SG)

(72) Inventors: Chi Hang KWOK, Singapore (SG); Kit Ying CHAN, Singapore (SG); Jia Hui CHEOK, Singapore (SG)

(73) Assignee: DR Laser Singapore Pte Ltd., Singapore (SG)

(21) Appl. No.: 19/048,321

(22) Filed: Feb. 7, 2025

(51) Int. Cl. B23K 26/21

(52) U.S. Cl. CPC B23K 26/21

(57) ABSTRACT

According to one aspect of the present disclosure, a method for soldering using pulsed laser light is provided. The method may include receiving, by a processor, a set of input parameters for soldering electronic components formed on a component substrate to solder materials formed on a target substrate. The method may include identifying, by the processor, a set of laser beam parameters for controlling the pulsed laser light based on the set of input parameters. The method may include controlling, by the processor, an application of the pulsed laser light to individually solder each of the electronic components and its corresponding solder material according to the set of laser beam parameters.

### TECHNICAL FIELD

The present disclosure relates to a method and apparatus for performing selective soldering of electronic components using pulsed laser light.

### BACKGROUND

Soldering is a fundamental process in the assembly of electronic devices. For instance, soldering may be used to join electrical components to printed circuit boards (PCBs) and other substrates. Traditional soldering techniques, such as reflow soldering, wave soldering, and manual soldering with a soldering iron, have been widely used for decades. These methods typically involve the application of heat to melt a solder material, which then cools to form a strong electrical and mechanical bond between the components.

However, conventional soldering methods present several challenges, particularly as electronic devices become smaller, more complex, and more sensitive to thermal stress. Reflow soldering, for example, subjects the entire assembly to elevated temperatures, which can lead to warping, damage to sensitive components, and/or reduce the reliability of the solder joints. Moreover, traditional soldering techniques may be unable to achieve the level of precision required for fine-pitch components and densely packed circuits.

To address these challenges, laser soldering techniques have been developed. Laser soldering uses a focused laser beam to deliver heat directly to the solder joint, offering greater precision and control compared to traditional methods. Continuous-wave (CW) lasers have been employed in various laser soldering applications, providing a steady stream of energy that can be used to melt the solder material. However, CW lasers can still introduce significant thermal stress to the surrounding areas due to the continuous application of heat, which may not be suitable for some applications, particularly those involving delicate components or materials with low thermal tolerance.

Pulsed laser soldering has emerged as an advanced alternative to CW laser soldering. In pulsed laser soldering, the laser emits light in short, controlled bursts or pulses, which allows for precise energy delivery with minimal thermal diffusion. The high peak power of each pulse is sufficient to melt the solder material quickly, while the short duration of the pulse minimizes the heat transfer to adjacent components. This makes pulsed laser soldering particularly advantageous in the assembly of microelectronic devices, where fine-scale precision and minimal thermal impact are critical.

Despite the advantages of pulsed laser soldering, challenges remain in optimizing the process for different solder materials, solder types, and geometries of components for soldering.

### SUMMARY

According to one aspect of the present disclosure, a method for soldering using pulsed laser light is provided. The method may include receiving, by a processor, a set of input parameters for soldering electronic components formed on a component substrate to solder materials formed on a target substrate. The method may include identifying, by the processor, a set of laser beam parameters for controlling the pulsed laser light based on the set of input parameters. The method may include controlling, by the processor, an application of the pulsed laser light to individually solder each of the electronic components and its corresponding solder material according to the set of laser beam parameters.

According to another aspect of the present disclosure, an apparatus for laser soldering is provided. The apparatus may include a laser source configured to emit pulsed laser light. The apparatus may include an optical system configured to focus the pulsed laser light onto a soldering area that includes an individual electronic component. The apparatus may include a control unit. The control unit may be configured to receive a set of input parameters for soldering electronic components formed on a component substrate to solder materials formed on a target substrate. The control unit may be configured to identify a set of laser beam parameters for controlling the pulsed laser light based on the set of input parameters. The control unit may be configured to cause the laser source to apply the pulsed laser light to individually solder each of the electronic components and its corresponding solder material according to the set of laser beam parameters.

### BRIEF DESCRIPTION OF THE DRAWINGS

The accompanying drawings, which are incorporated herein and form a part of the specification, illustrate aspects of the present disclosure and, together with the description, further serve to explain the principles of the present disclosure and to enable a person skilled in the pertinent art to make and use the present disclosure.

FIG. 1A is a diagram illustrating a first example soldering technique.

FIG. 1B is a diagram illustrating a second example soldering technique.

FIG. 2 is a block diagram schematically illustrating an exemplary laser soldering system, according to some aspects of the present disclosure.

FIG. 3A is a diagram illustrating a cross-sectional view of a component substrate and a target substrate before alignment, according to some aspects of the present disclosure.

FIG. 3B is a diagram illustrating a cross-sectional view of a component substrate and a target substrate after alignment, according to some aspects of the present disclosure.

FIG. 3C is a diagram illustrating a cross-sectional view of a component substrate and a target substrate after soldering, according to some aspects of the present disclosure.

FIG. 4A is a diagram illustrating a solder material layout on a target substrate, according to some aspects of the present disclosure.

FIG. 4B is a diagram illustrating an array of electronic components on a component substrate, according to some aspects of the present disclosure.

FIG. 4C is a diagram illustrating the alignment and attachment of electronic components with their corresponding solder materials, according to some aspects of the present disclosure.

FIG. 5A is a diagram illustrating a first exemplary soldering technique in which pulsed laser light is applied to an area smaller in size than a soldering area, according to some aspects of the present disclosure.

FIG. 5B is a diagram illustrating a second exemplary soldering technique in which pulsed laser light covers an area larger in size than a soldering area, according to some aspects of the present disclosure.

FIG. 6 is a diagram illustrating an exemplary laser soldering technique applied to Ball Grid Array (BGA) components, according to some aspects of the present disclosure.

FIG. 7 illustrates a block diagram of an exemplary control unit for controlling a laser soldering system, according to some aspects of the present disclosure.

FIG. 8 illustrates a flowchart of an exemplary method of laser soldering, according to some aspects of the present disclosure.

The present disclosure will be described with reference to the accompanying drawings.

### DETAILED DESCRIPTION

Although specific configurations and arrangements are discussed, it should be understood that this is done for illustrative purposes only. As such, other configurations and arrangements can be used without departing from the scope of the present disclosure. Also, the present disclosure can be employed in a variety of other applications. Functional and structural features as described in the present disclosures can be combined, adjusted, and modified with one another and in ways not specifically depicted in the drawings, such that these combinations, adjustments, and modifications are within the scope of the present disclosure.

In general, terminology may be understood at least in part from usage in context. For example, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

When performing pulsed laser soldering, various factors such as wavelength, pulse duration, energy, repetition rate, and beam spot size can be controlled to provide consistent and reliable solder joints. For instance, wavelength selection is important because it determines the absorption efficiency of the solder material and the underlying substrate(s).

Laser energy and repetition rate also play significant roles. The energy per pulse must be sufficient to melt the solder material fully, yet not so high as to cause splattering or damage to the substrate. Typical energy levels are carefully matched to the solder volume and solder joint size, often ranging from a few microjoules to several joules per pulse. The repetition rate determines how frequently the laser pulses are emitted, thereby affecting the overall process speed and the thermal build up in the material. A higher repetition rate can increase processing speed but requires careful management to prevent excessive thermal accumulation.

Pulse duration is another factor to consider when performing pulsed laser soldering because it influences the thermal diffusion and the cooling rate of the solder material. For fine-pitch components, shorter pulse durations (on the order of picoseconds to microseconds) are preferred to limit the heat-affected zone (HAZ) and prevent damage to nearby components. A precise control of pulse duration allows the solder to melt without excessive thermal spread. This ensures that only the intended area is affected.

Beam spot size is also important, as it defines the area over which the laser energy is distributed. A smaller spot size allows for higher precision, essential for microelectronic applications where components are densely packed. However, larger spot sizes may be used when uniform heating of a slightly larger area is performed to ensure proper solder flow and joint formation. The ability to dynamically adjust the spot size allows for flexibility in the soldering process, accommodating a variety of joint geometries and component sizes.

Moreover, laser beam shaping plays a pivotal role in optimizing energy distribution across the solder joint. Techniques such as using diffractive optical elements (DOEs) or spatial light modulators (SLMs) allow for the customization of the beam profile, enabling uniform heating even in complex geometries. The laser beam may be shaped to create a tailored intensity profile that matches the solder joint's specifications, thereby reducing thermal gradients and ensuring a more uniform joint. This may be beneficial in applications involving irregular or fine-pitch components where traditional Gaussian beam profiles might not provide adequate coverage or might cause localized overheating.

In summary, the control and optimization of these factors (e.g., wavelength, pulse duration, energy, repetition rate, beam spot size, etc.) may help achieve reliable and high-quality solder joints in pulsed laser soldering. These parameters may be precisely tailored based on application to ensure that the soldering process is both effective and efficient, while minimizing the risk of thermal damage to the components.

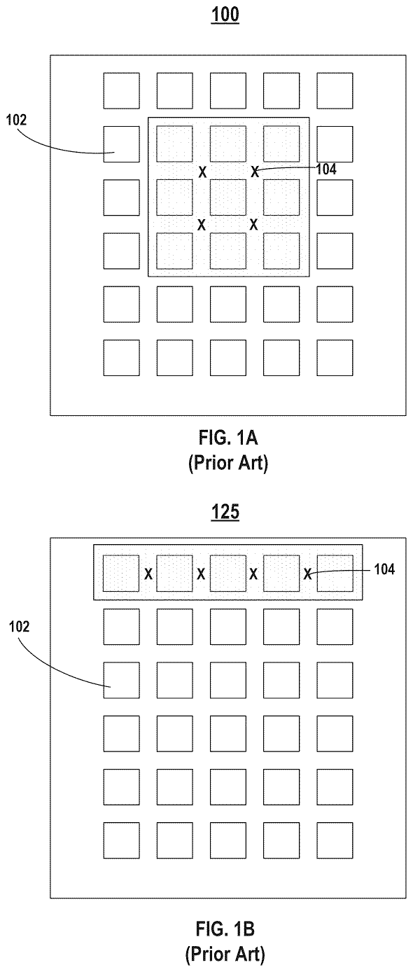

Existing laser soldering techniques solder electronic components in bulk, as described below in connection with FIGS. 1A and 1B.

FIGS. 1A and 1B depict an existing area soldering technique 100 and an existing line soldering technique 125, respectively. In FIGS. 1A and 1B, the HAZ is depicted with shading. As shown in FIG. 1A, area soldering applies a laser beam to an area that includes a two-dimensional array of electronic components 102. On the other hand, as shown in FIG. 1B, line soldering applies a laser beam to an area that includes a one-dimensional array of electronic components 102. Both area and line soldering may affect neighboring areas that are not required to be soldered, leading to several disadvantages.

For example, the broad application of heat can result in collateral damage to components that are not intended to be soldered as shown by “X” marks 104. Sensitive components, such as those with low thermal tolerance, are particularly at risk of damage, which can lead to malfunction or failure of the entire assembly. Additionally, area and line soldering are prone to creating inconsistent solder joints due to the uneven distribution of heat. This can lead to defects such as cold joints, solder bridges, or voids, all of which compromise the reliability and performance of the final product.

Furthermore, traditional laser soldering techniques methods are generally not energy-efficient, as they require more power to heat large areas, even when only a small portion needs to be soldered. This inefficiency not only increases operational costs but also contributes to unnecessary thermal stress to the components and substrates, potentially leading to mechanical failures such as warping or cracking. The heating of large areas can also exacerbate thermal stress, particularly in assemblies with components that have different coefficients of thermal expansion, further increasing the risk of damage.

In bulk laser soldering, electronic components are soldered regardless of whether the electronic components are in functional or faulty condition. In other words, electronic components are soldered without selectivity in bulk soldering. Soldering faulty electronic components wastes energy and can cause undue thermal stress to the substrate and surrounding electronic components.

Thus, there remains an unmet need for a laser soldering technique that enhances the adaptability and reliability of pulsed laser soldering across diverse electronic assembly applications, while at the same time provides selectivity in which electronic components are soldered.

To overcome these and other challenges, the present disclosure provides an exemplary laser soldering system that utilizes pulsed laser technology to selectively solder individual electronic components, which achieves precise and controlled soldering without undue thermal stress to the surrounding areas of the substrate. Moreover, the present laser soldering system may selectively solder only those functional electronic components. In other words, soldering of faulty electronic components may be skipped, thereby reducing the overall thermal stress applied to the target substrate and improving energy efficiency.

The present laser soldering system is composed of various components, e.g., including a control unit, a motion system, a laser source, and an optical system. The control unit may be configured to control the motion system(s), identify input parameters for use in soldering, and optical system positioning. The motion system(s) may be configured to align a component substrate and target substrate. The laser source may be configured to generate the pulsed laser beam used in the present soldering process, and the optical system may be configured to focus the pulsed laser light onto an individual electronic component for soldering.

The present laser soldering system aligns electronic components formed on a component substrate with a solder paste layout formed on a target substrate. After alignment, the component substrate and target substrate are brought into contact under controlled pressure, and pulsed laser light is focused onto the target location to selectively melt the solder material, thereby individually bonding its corresponding electronic component to the target substrate.

A benefit of the present laser soldering system is its ability to precisely control input parameters, such as wavelength, pulse duration, energy, repetition rates, distribution profile, etc. This control allows for the accurate melting and solidification of the solder material, resulting in high-quality solder joints with minimized thermal stress on surrounding components. The system also offers flexibility in varying the laser spot size relative to the target area but not limited to laser spot shape, enabling either highly localized heating or broader coverage. By way of example and not limitation, a smaller laser spot size (e.g., covering approximately 80% of the target area) provides precise heating and minimizes thermal damage to nearby electronic components. In contrast, a larger spot size (e.g., covering around 150% of the target area) may ensure uniform heating and enhance solder wetting, which promotes the formation of more robust and reliable solder joints.

The input parameters may also include an indication of a subset of electronic components for soldering. For instance, the subset of electronic components may include only functional electronic components formed on the component substrate. In other words, the subset may exclude faulty electronic components.

In this way, the present laser soldering system addresses the drawbacks of traditional soldering techniques, such as collateral thermal damage, inconsistent solder joints, and inefficient energy use. The present laser soldering system is particularly well-suited for modern electronics manufacturing, where precision, reliability, and efficiency are essential. Its adaptability makes it effective for various applications, including fine-pitch connectors and Ball Grid Arrays (BGAs), where it delivers controlled heat with pinpoint accuracy, ensuring strong, reliable connections, while minimizing thermal stress on surrounding components. This precision ensures that each solder joint is formed with optimal heat application, leading to stronger, more reliable connections. The present system's flexibility in adjusting the laser spot size also means it can be adapted to various soldering tasks, from the delicate soldering of fine-pitch connectors to the more robust requirements of lead frame soldering in dual in-line packages (DIPs). Moreover, the present laser soldering system may selectively solder only those functional electronic components, reducing the overall thermal stress applied to the target substrate.

Overall, the present laser soldering system represents a significant advancement in soldering technology, offering a versatile and efficient solution for the precise soldering of individual electronic components in high-density and sensitive electronic assemblies. It provides enhanced precision, reduced thermal impact on delicate components, and the ability to perform soldering in complex or constrained environments, making it a valuable advancement in the assembly of electronic components for high-precision electronics applications where reliability and performance are beneficial.

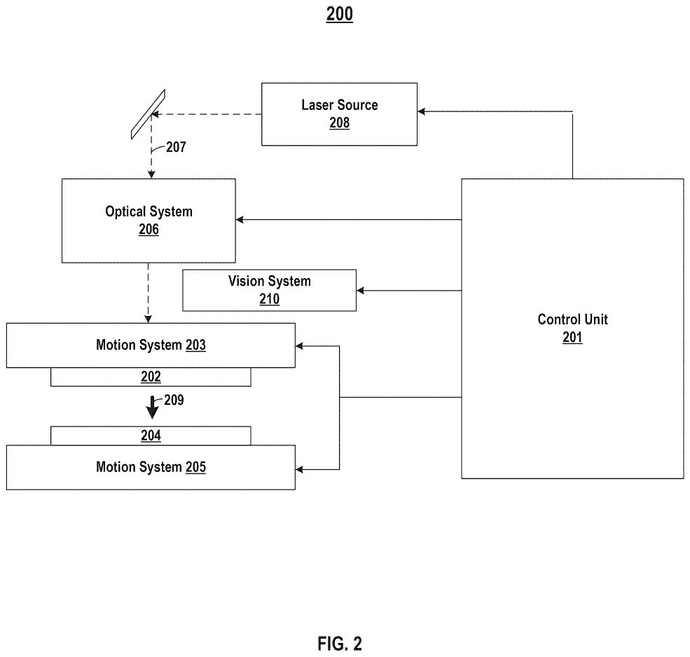

FIG. 2 is a block diagram schematically illustrating an exemplary laser soldering system 200, according to some aspects of the present disclosure. Laser soldering system 200 may include, e.g., a control unit 201, motion systems 203, 205, an optical system 206, a laser source 208, and a vision system 210. Control unit 201 may control one or more of the motion systems 203, 205, the optical system 206, and the laser source 208 based on a set of input parameters.

Referring to FIG. 2, a component substrate 202 is shown attached to a bottom surface of motion system 203, while the target substrate 204 is shown attached to a top surface of motion system 205. In some implementations, an array of electronic components may be formed on component substrate 202, while a solder material layout may be formed on target substrate 204. In some other implementations, the solder material layout may both be formed on component substrate 202 rather than target substrate 204. In either case, relative motion between the component substrate 202 and target substrate 204 is accomplished using motion systems 203, 205.

Vision system 210 may include a set of cameras and lens to enable the precise alignment of each of the electronic components formed on component substrate 202 with its corresponding solder material formed on target substrate 204. Vision system 210 may send a signal to motion system 203 to indicate when alignment is complete. Motion system 203, 205 may then bring component substrate 202 and the target substrate 204 into contact.

Motion systems 203, 205 are located under an optical system 206, which can focus pulsed laser light 207 emitted by a laser source 208. The soldering of the electronic component is shown as a uniting action on a predetermined location on the target substrate 204 by arrow 209 to a disuniting action from the component substrate 202.

Optical system 206 may include a lens (e.g., objective lens, f-theta lens, etc.), and control unit 201 may control the distance and/or position of the lens with respect to component substrate 202 and target substrate 204 to achieve a desired beam spot size.

Once component substrate 202 and target substrate 204 are aligned and in contact and the lens of optical system 206 is in position, control unit 201 may cause the laser source 208 to emit pulsed laser light 207 that meets the set of laser parameters indicated by the input parameters. The lens of optical system 206 focuses the pulsed laser light onto a target area that includes an individual electronic component and its corresponding solder material. Laser source 208 may include a solid laser, a gas laser, or a fiber laser, just to name a few. Laser source 208 may output pulsed laser light output with a wavelength in the ultraviolet range of 200-400 nm, visible range of 400-700 nm, or infrared range of 700-1000 nm.

Depending on the melting behavior and the optical absorption properties of the solder material, the wavelengths that can exert effective absorption to the solder material will be chosen. For example, laser wavelength from the near infrared region (700-1000 nm) will be used for low melting points solder materials (such as indium or tin paste) that are commonly used for electronic components. For silver paste or copper soldering, a wavelength in the green (490 to 570 nm) or UV (200 to 400 nm) region will then be selected due to the high absorption rate of these wavelengths and the high melting temperatures of the materials.

Further to the selection of a proper wavelength for the soldering process, laser pulse width also acts as an important factor in controlling the quality of the soldered joint and in maintaining the functionality of the soldered devices. The choice of the pulse width also affects the thermal profile during soldering, directly influencing the precision of the process and the potential thermal damage to surrounding components. The present inventions allow the laser system with different pulse width, ranging from 10 femtosecond (fs) to 1 microsecond (us), to be used according to the solder material and the device properties.

As an example, shorter pulse widths (10 fs to 100 ps) laser will be used for highly reflective materials like gold and copper, which are difficult to heat using standard continuous wave lasers or longer pulse lasers. Short pulse lasers are preferred with these materials as they can provide high peak power in a brief period, which overcomes the reflective nature of these materials and enables effective soldering. Longer pulse width laser (1 ns to 100 ns) may be selected for soft soldering material such as tin and lead due to their relatively low melting temperature. Longer pulses also allow better control over the solder flow and provide a stronger joint due to more uniform heating.

Energy applied to the soldering material also affects the strength and reliability of the soldering joint. Optical system 206 and laser source 208 allow various amount of energy to be applied to the solder joint by adjusting the settings of the laser source 208. The adjustable energy range can vary from 1 uJ to 500 mJ and the suitable amount of energy to be applied for the soldering process will be chosen according to the size of the devices to be soldered, the area that needs to be soldered, the thickness of the solder pastes and the types of materials to be soldered. For soldering materials with lower melting temperature and to delicate components of smaller sizes, lower energy in the range of 50 uJ to 10 mJ will be applied. Example for such type of soldering will be the soldering process for micro light-emitting diodes (microLEDs), fine-pitch BGAs, or chip-on-board components.

Higher energy in the range of 100 mJ to 500 mJ will be applied to larger components, such as surface mount devices (SMDs), where the solder joints are larger, or the material is thicker. Higher energy pulses provide sufficient heat to ensure the solder melts and flows across the joint. However, the energy must be carefully controlled to avoid damaging surrounding components, especially when different materials with varying thermal expansion coefficients are involved.

Laser repetition rate has a significant impact on the laser soldering process, affecting both the efficiency and the quality of the soldering joint. In the present disclosure, repetition rate ranging from 1 kHz to 1 MHz can be applied depending on the types of laser sources adopted in the system. High repetition rate (50 kHz to 1 MHz) of the laser soldering system will be chosen for larger-scale soldering for surface-mount devices (SMDs) or larger printed circuit boards (PCBs), for example.

Low repetition rate allows more time for the solder material to cool between pulses. This can result in a more controlled heating profile, minimizing overheating and thermal distortion in areas surrounding the solder joint. Soldering for delicate micro-electronics may use lower repetition rate with the range of 1 kHz to 10 kHz for precisely controlling the heat accumulation of the soldered devices.

According to the present laser soldering technique, the laser beam distribution profile can also be adjusted according to the needs of the soldering components and solder joint with the use of beam shaping optics. The laser beam distribution profile may include, but is not limited to, a Gaussian distribution, a super Gaussian distribution, or a top-hat distribution profile. Depending on the soldering area or the properties of the solder material, respective beam distribution profiles can be selected. The Gaussian distribution may be useful for tasks that require localized heat to melt solder material or form solder joints without affecting adjacent components. For example, when soldering MicroLEDs or fine-pitch BGAs, it is crucial to target only the specific area of the component being soldered, minimizing thermal damage to the surrounding circuitry. The precision focus of the Gaussian profile ensures that only the target region is heated, while the gradual tapering of energy prevents overheating of nearby components. The resulting minimal thermal impact and high-precision heating make it an excellent choice for delicate soldering operations, ensuring reliable solder joints with minimal risk of collateral thermal damage.

The Top-Hat distribution may be beneficial in situations requiring uniform heating across a large area. For example, in reflow soldering of large flat components or surface-mount devices (SMDs), it ensures that the entire surface of the solder paste or electronic component receives consistent energy, promoting uniform reflow. The consistent energy application of the Top-Hat distribution is also advantageous in area-based treatments or large-scale bonding processes, where the heat must be evenly distributed to ensure homogeneous solder joints and reliable connections without risk of thermal damage or inconsistent joint formation. The use of the Top-hat profile also minimizes the risk of overheating at the center or insufficient heating at the edges of the solder joint.

Still referring to FIG. 2, depending on the scale of soldering, the solder materials, the types of devices to be soldered and the speed required for the soldering process, the present laser soldering technique can be realized with the use of an objective lenses or scanhead with F-theta lens located in optical system 206. Objective lenses are fixed or movable lenses used to focus the laser beam onto a small, precise spot. They are often used in precision soldering where accuracy and fine control are critical. Soldering on the solder joints of BGA components requires precise energy and position control. Objective lenses can be used in the process to ensure the energy is delivered accurately to the target area of the solder joints.

A scan head with an F-theta lens allows the laser beam to be deflected over a wide area using high-speed galvanometer mirrors, while the F-theta lens ensures consistent focus across the entire scanned area. A scanhead with F-theta lens system is usually applied to large area soldering with low thermal tolerance between the devices. To maintain the productivity and avoid unnecessary heat up of the thermal sensitive areas, the scanhead with an f-theta lens system may be selected to achieve the solder joint quality and efficiency.

Moreover, when the input parameters indicates a subset of electronic components formed on component substrate 202 are selected for soldering, control unit 201 may cause one or more of motion systems 203, 205, optical system 206, or laser source 208 to adjust position in between soldering of individual electronic components so that only those electronic components indicated in the subset are soldered. For instance, after one electronic component of the subset is soldered, control unit 201 may cause one or more of motion system 203, 205, optical system 206, or laser source 208 to reposition so that another electronic component is now located beneath the lens of optical system 206 for selective soldering.

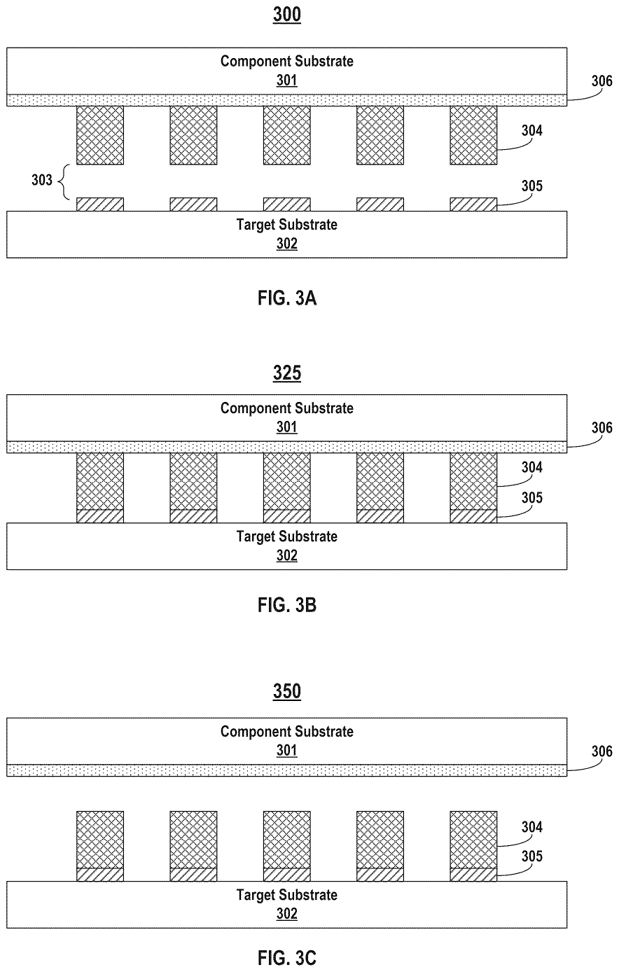

FIG. 3A is a diagram illustrating a cross-sectional view 300 of a component substrate and a target substrate before alignment, according to some aspects of the present disclosure. FIG. 3B is a diagram illustrating a cross-sectional view 325 of a component substrate and a target substrate after alignment, according to some aspects of the present disclosure. FIG. 3C is a diagram illustrating a cross-sectional view 350 of a component substrate and a target after soldering, according to some aspects of the present disclosure. FIGS. 3A-3C will be described together.

As shown in FIGS. 3A and 3B, a plurality of electronic components 304 are attached to a lower surface component substrate 301 via an adhesive layer 306, and a plurality of solder materials 305 are attached to an upper surface of target substrate 302. During alignment, component substrate 301 is positioned over target substrate 302 with a gap 303 so that each electronic component 304 is aligned with its corresponding solder material 305, as shown in FIG. 3A. Following the completion of the alignment procedure, component substrate 301 is brought into contact with target substrate 302 under controlled pressure, as depicted in FIG. 3B. Pulsed laser light is then directed at the target area (e.g., an area that includes a single electronic component 304 and its corresponding solder material 305), passing through adhesive layer 306 and selectively melting solder material 305. This process facilitates the individually bonding of each electronic component 304 to target substrate 302, as illustrated in FIG. 3C.

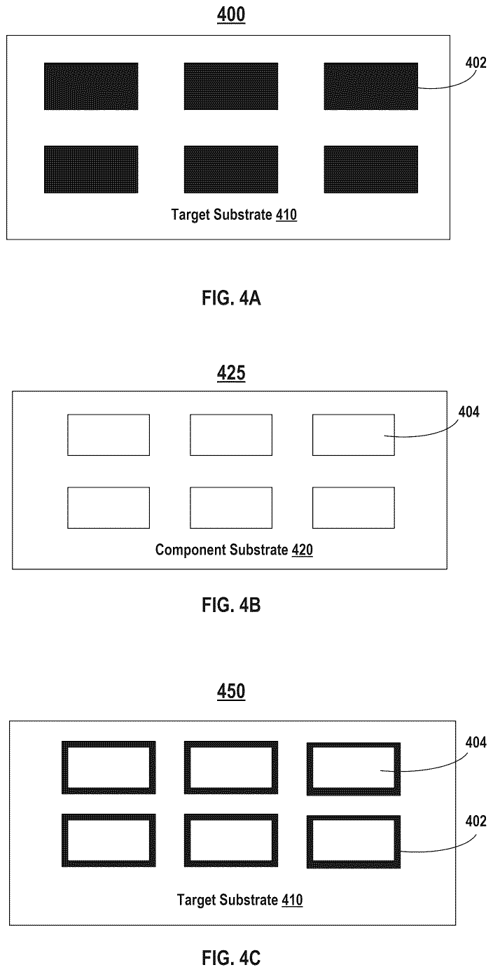

FIG. 4A is a diagram illustrating a solder material layout 400 formed on a target substrate, according to some aspects of the present disclosure. FIG. 4B is a diagram illustrating an array of electronic components 425 formed on a component substrate, according to some aspects of the present disclosure. FIG. 4C is a diagram illustrating the alignment and attachment 450 of electronic components with their corresponding solder materials, according to some aspects of the present disclosure. FIGS. 4A-4C will be described together.

FIG. 4A depicts solder material 402 formed in an array on a target substrate 410, and FIG. 4B depicts electronic components 404 formed in an array on a component substrate 420. Referring to FIG. 4C, each electronic component 404 on the component substrate 420 is aligned with its corresponding solder material 402 on the target substrate 410, where electronic component 404 fully contacts its solder material 402. Once aligned, the control unit may cause the laser source to emit pulsed laser light to individually solder each electronic component 404 to the target substrate 410.

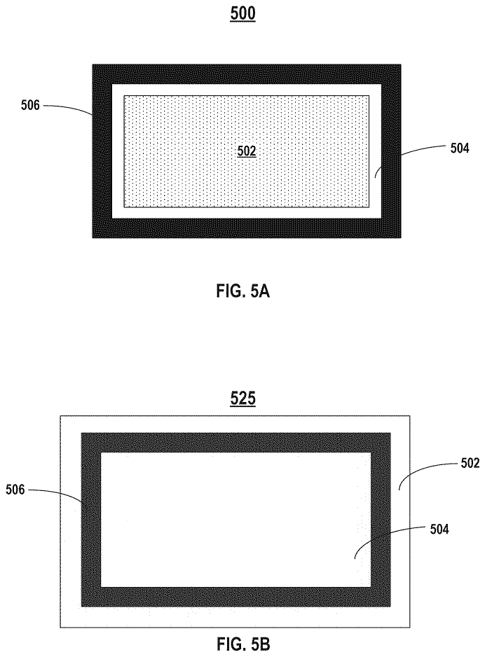

FIG. 5A is a diagram illustrating a first exemplary soldering technique 500 in which pulsed laser light is applied to an area smaller in size than a soldering area, according to some aspects of the present disclosure. FIG. 5B is a diagram illustrating a second exemplary soldering technique 525 in which pulsed laser light covers an area larger in size than a soldering area, according to some aspects of the present disclosure. In FIGS. 5A and 5B, the laser spot size is depicted with shading. FIGS. 5A and 5B will be described together.

As illustrated in FIG. 5A, one of the benefits of the present laser soldering system is its ability to vary the size of the laser spot 502 relative to the target area (e.g., that includes a single electronic component 504 and its corresponding solder material 506). For instance, when the laser spot 502 is smaller than the target area (e.g., covering approximately 80% of the target area), highly localized heating may be achieved. This level of precision is particularly advantageous in scenarios where nearby components or areas must not be exposed to heat. By focusing the energy precisely on the solder joint, the risk of collateral thermal damage is significantly reduced. This feature is especially beneficial in the assembly of fine-pitch components, such as those found in high-density electronic circuits or microelectronic component displays, where each connection must be made with extreme accuracy.

Conversely, referring to FIG. 5B when the size of laser spot 502 is larger than the target area (e.g., covering around 150% of the target area), uniform heating of the entire target area and its immediate surroundings may be achieved. This broader coverage is useful in applications where consistent solder joint quality is crucial. The larger spot size enhances solder wetting and promotes more robust bonding, as the surrounding areas are also heated, aiding in the even distribution of solder. Additionally, this approach simplifies the alignment process, as the larger spot reduces the need for exact positioning, thereby increasing the ease of use and reducing the potential for errors due to slight misalignments.

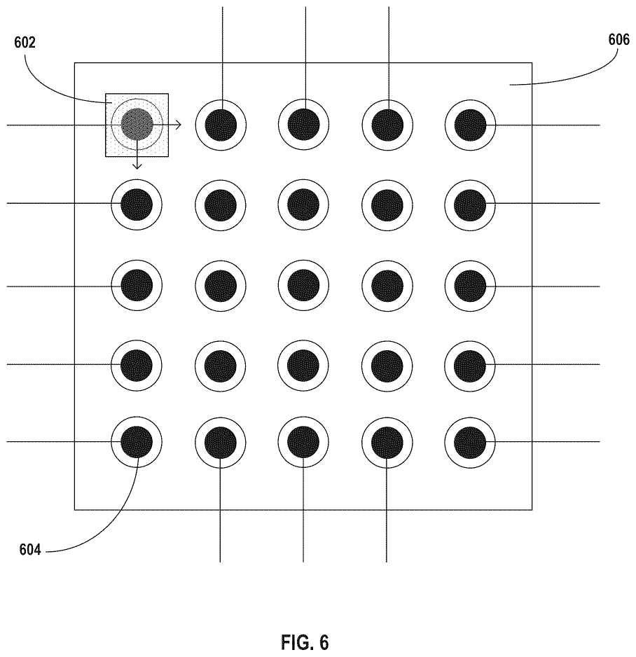

FIG. 6 is a diagram illustrating an exemplary point laser soldering technique 600 applied to BGA components, according to some aspects of the present disclosure. The view depicted in FIG. 6 may be a bottom side view of the target substrate 606, which may include a PCB, for example.

Referring to FIG. 6, point laser soldering 602 is highly effective for BGA components, which require precise and reliable connections between the solder balls 604 and the PCB. By focusing a laser beam with pinpoint accuracy, this technique delivers controlled heat directly to individual solder balls, minimizing thermal stress on nearby components and the PCB. The ability to fine tune the laser's energy and selectively reflow specific solder joints makes point laser soldering ideal for both initial assembly and rework of BGAs. This non-contact process ensures high precision and reduces the risk of mechanical damage or contamination, ultimately enhancing the reliability of BGA connections in advanced electronic devices.

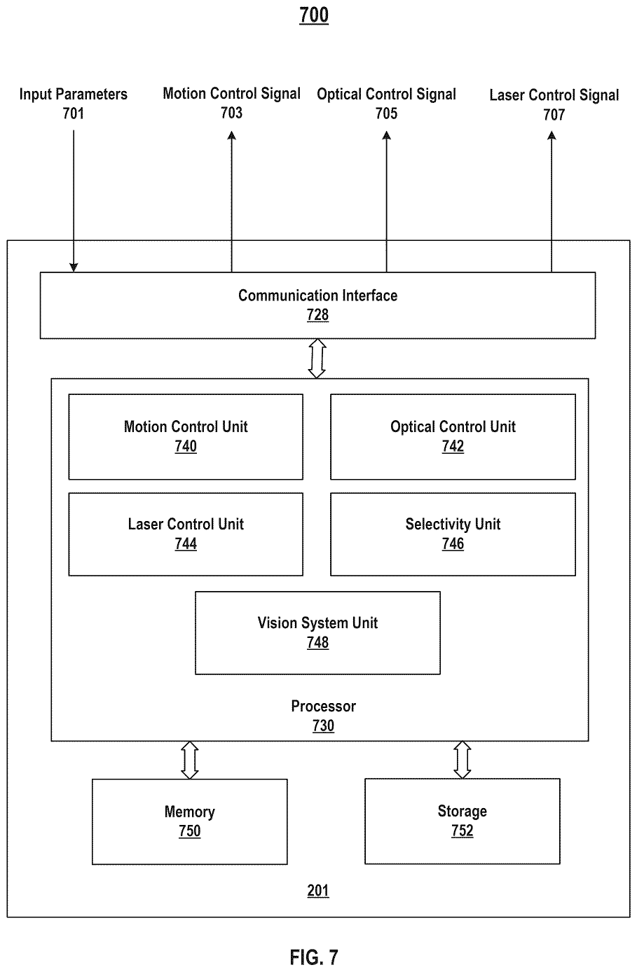

FIG. 7 shows an exemplary implementation 700 of control unit 201 of FIG. 2, according to aspects of the disclosure.

In some embodiments, as shown in FIG. 7, control unit 201 may include a communication interface 728, a processor 730, a memory 750, and a storage 752. In some embodiments, control unit 201 may have different modules in a single device, such as an integrated circuit (IC) chip (implemented as, for example, an application-specific integrated circuit (ASIC) or a field-programmable gate array (FPGA)), or separate devices with dedicated functions. In some embodiments, one or more components of control unit 201 may be located in a cloud, or may be alternatively in a single location or distributed locations. Components of control unit 201 may be in an integrated device, or distributed at different locations but communicate with each other through a network.

Communication interface 728 may send data to and receive data from components such as the motion systems, optical system, and/or laser source via communication cables, a Wireless Local Area Network (WLAN), a Wide Area Network (WAN), wireless communication links such as radio waves, a cellular network, and/or a local or short-range wireless network (e.g., Bluetooth™), or other communication methods. In some embodiments, communication interface 728 can be an integrated services digital network (ISDN) card, cable modem, satellite modem, or a modem to provide a data communication connection. As another example, communication interface 728 can be a local area network (LAN) card to provide a data communication connection to a compatible LAN. Wireless links can also be implemented by communication interface 728. In such an implementation, communication interface 728 can send and receive electrical, electromagnetic or optical signals that carry digital data streams representing various types of information.

Consistent with some embodiments, communication interface 728 may receive a set of input parameters 701 for use in laser soldering. Input parameters 701 may include, e.g., a set of laser beam parameters for use in controlling a laser source. In some implementations, input parameters 701 may include an indication of a subset of electronic components for soldering. The subset of electronic components may include functional electronic components and exclude faulty electronic components, for example. Communication interface 728 may transmit the received input parameters 701 to processor 730 for processing.

Processor 730 may include any appropriate type of general-purpose or special-purpose microprocessor, digital signal processor, or microcontroller. Processor 730 may be configured as a stand-alone processor module dedicated to analyzing signals (e.g., input parameters 701) and/or controlling the operations of the motion system(s), the optical system, the laser source, etc. Alternatively, processor 730 may be configured as a shared processor module for performing other functions unrelated to signal analysis/scan scheme control.

As shown in FIG. 7, processor 730 may include multiple functional units or modules that can be implemented using software, hardware, middleware, firmware, or any combination thereof. For example, processor 730 may include a motion control unit 740, an optical control unit 742, a laser control unit 744, a selectivity unit 746, and a vision system unit 748.

Vision system unit 748 may be configured to identify the pattern of the electrical components and/or solder material layout. Vision system 748 may send a signal indicating the pattern of the electrical components and/or solder material layout to motion control unit 740 once each of the electronical components is aligned with its corresponding solder material.

Motion control unit 740 may be configured to control the motion system(s) to position the component substrate and the target substrate so that each electronic component on the component substrate is aligned with and contacts is corresponding solder material on the target substrate based on the signal received from vision system unit 748. Motion control unit 740 may generate a motion control signal 703 to control the positioning and alignment performed by the motion system(s).

In some embodiments, processor 730 may send input parameters 701 to optical control unit 742 and laser control unit 744. Optical control unit 742 and laser control unit 744 may identify a set of laser beam parameters based on input parameters 701. Optical control unit 742 be configured may control the position of the optical system's lens to achieve the beam spot size indicated by the laser beam parameters. For instance, optical control unit 742 may generate an optical control signal 705 that instructs the optical system to position the lens with respect to the component and target substrates so that the desired beam spot size is achieved. The laser control unit 744 may control the laser source to emit pulsed laser light based on the laser beam parameters. For instance, laser control unit 744 may generate a laser control signal 707. The laser control signal 707 may instruct the laser source to output pulsed laser light based on laser beam parameters indicated by the input parameters 701. The laser beam parameters may include one or more of, e.g., pulse width, laser energy,, laser wavelength, laser repetition rate, or distribution profile.

In some embodiments, processor 730 may send input parameters 701 to selectivity unit 746. Selectivity unit 746 may identify a subset of electronic components formed on the component substrate for soldering. For example, the input parameters 701 may indicate one or more of functional electronic components or faulty electronic components, and their relative positions on the component substrate. Selectivity unit 746 may send information associated with the subset of electronic components to one or more of motion control unit 740, optical control unit 742, or laser control unit 744. In some implementations, motion control unit 740 may generate a motion control signal 703 the instructs the motion system(s) to adjust the position of the aligned component substrate and target substrate to a position under the optical system so that only electronic components in the subset are soldered. In some implementations, optical control unit 742 may generate an optical control signal 705 the instructs the optical system to adjust the position of the lens with respect to the component substrate and target substrate so that only electronic components in the subset are soldered. In some implementations, laser control unit 744 may generate a laser control signal 707 the instructs the laser source to adjust its position with respect to the component substrate and target substrate so that only electronic components in the subset are soldered.

Units 740, 742, 744, 746, and 748 (and any corresponding sub-modules or sub-units) can be hardware units (e.g., portions of an integrated circuit) of processor 730 may be designed for operation independently or with other components or software units implemented by processor 730 through executing at least part of a program. The program may be stored on a computer-readable medium. When the program is executed by processor 730, the executed program may cause processor 730 to perform one or more functions or operations. Although FIG. 7 shows units 740-748 all within one processor 730, it is contemplated that these units may be distributed among multiple processors located close to or remotely with each other.

Memory 750 and storage 752 may include any appropriate type of mass storage provided to store any type of information that processor 730 may need to operate. Memory 750 and/or storage 752 may be volatile or non-volatile, magnetic, semiconductor-based, tape-based, optical, removable, non-removable, or other type of storage device or tangible (i.e., non-transitory) computer-readable medium including, but not limited to, a ROM, a flash memory, a dynamic RAM, a static RAM, a hard disk, an SSD, an optical disk, etc. Memory 750 and/or storage 752 may be configured to store one or more computer programs that may be executed by processor 730 to perform the operations disclosed herein. For example, memory 750 and/or storage 752 may be configured to store program(s) that may be executed by processor 730 to perform selective pulsed laser soldering.

Memory 750 and/or storage 752 may be further configured to store/cache information and data received and/or used by processor 730. For instance, memory 750 and/or storage 752 may be configured to store/cache input parameters 701 (e.g., the set of laser beam parameters and/or an indication the subset of electronic components) and calculation results obtained by different units of processor 730. The various types of data may be stored permanently, removed periodically, or disregarded immediately after each frame of data is processed.

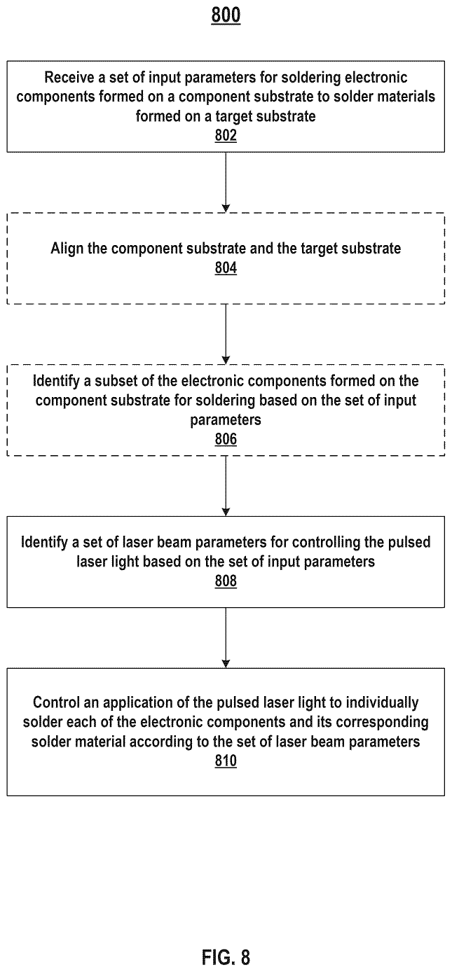

FIG. 8 illustrates a flowchart of an exemplary method 800 of soldering using pulsed laser light, according to some aspects of the present disclosure. Method 800 may be performed by an apparatus, e.g., such as laser soldering system 200, control unit 201, motion system 203, motion system 205, optical system 206, laser source 208, vision system 210, communication interface 728, processor 730, memory 750, storage 752, motion control unit 740, optical control unit 742, laser control unit 744, selectivity unit 746, or vision system unit 748, just to name a few. Method 800 may include operations 802-810, as described below. It is to be appreciated that some of the steps may be optional (such as those indicated with dashed lines or others not so indicated), and some of the steps may be performed simultaneously, or in a different order than shown in FIG. 8.

Referring to FIG. 8, at 802, the apparatus may receive a set of input parameters for soldering electronic components formed on a component substrate to solder materials formed on a target substrate. For example, referring to FIG. 7, processor 730 may receive input parameters 701 via communication interface 728. Input parameters 701 may be received via user input or generated based on device specifications. The device specifications may include spacing between electronic components, material(s) used for the electronic components, etc. In some implementations, the input parameters may include a set of laser beam parameters for use in soldering and/or an indication of a subset of electronic components formed on the component substrate for soldering.

At 804, the apparatus may align the component substrate and the target substrate. For example, referring to FIG. 7, motion control unit 740 may be configured to control the motion system(s) the position of the component substrate and the target substrate so that each electronic component on the component substrate is aligned with and contacts its corresponding solder material on the target substrate. Motion control unit 740 may generate a signal to control the positioning and alignment performed by the motion system(s).

At 806, the apparatus may identify a subset of the electronic components formed on the component substrate for soldering based on the set of input parameters. In some implementations, the input parameters may include an indication of a subset of electronic components formed on a component substrate for soldering. For example, referring to FIG. 7, selectivity unit 746 may identify a subset of electronic components formed on the component substrate for soldering. For example, the input parameters 701 may indicate one or more of functional electronic components or faulty electronic components, and their relative positions on the component substrate.

At 808, the apparatus may identify a set of laser beam parameters for controlling the pulsed laser light based on the set of input parameters. The set of laser beam parameters may include one or more of laser wavelength, pulse width, laser energy, laser repetition rate, distribution profile, or laser spot size. In some implementations, the pulse width may be in a range of 1 femtosecond to 1 microsecond. In some implementations, the laser energy may be in a range of 1 microjoule to 10 joules. In some implementations, the laser wavelength may be in a range of 200 nanometers to 1000 nanometers. In some implementations, the laser repetition rate is in a range of 1 kHz to 1 MHz. In some implementations, the distribution profile may include one of a Gaussian distribution, a Laguerre Gaussian distribution, or a Top-hat distribution. For example, referring to FIG. 7, processor 730 may send input parameters 701 to optical control unit 742 and laser control unit 744, which may identify a set of laser beam parameters. For instance, optical control unit 742 may identify a laser spot size, and laser control unit 744 may identify the laser wavelength, pulse width, laser energy,, laser repetition rate, and/or distribution profile for use in generating pulsed laser light.

At 810, the apparatus may control the pulsed laser light to individually solder each of the electronic components and its corresponding solder material according to the set of laser beam parameters. In some implementations, the apparatus may control the pulsed laser light to individually solder all electronic components formed on the component substrate. In some implementations, the apparatus may control the pulsed laser light to individually solder only those electronic components included in the subset. In some implementations, the apparatus may control the pulsed laser light by causing a laser source to output the pulsed laser light according to the set of laser beam parameters. In some implementations, the apparatus may control the pulsed laser light by identifying a beam size to individually solder each of the electronic components and its corresponding solder material according to the set of laser beam parameters. In some implementations, the apparatus may control the pulsed laser light by positioning a lens of an optical system with respect to the component substrate and the target substrate to focus the pulsed laser light into the beam size onto an individual electronic component and its corresponding solder material. In some implementations, the lens of the optical system comprises an objective lens or an f-theta lens. In some implementations, the apparatus may control the pulsed laser light by controlling the pulsed laser light to only impinge on a target area that includes a single electronic component and its corresponding solder material. In some implementations, a beam size of the pulsed laser light may be smaller or larger than a size of an individual electronic component. For example, referring to FIG. 7, optical control unit 742 be configured may control the position of the optical system's lens to achieve the beam spot size indicated by the laser beam parameters. For instance, optical control unit 742 may generate an optical control signal 705 that instructs the optical system to position the lens with respect to the component and target substrates to that the desired beam spot size is achieved. Selectivity unit 746 may send information associated with the subset of electronic components to one or more of motion control unit 740, optical control unit 742, or laser control unit 744. In some implementations, motion control unit 740 may generate a motion control signal 703 that instructs the motion system(s) to adjust the position of the aligned component substrate and target substrate to a position under the optical system so that only electronic components in the subset are soldered. In some implementations, optical control unit 742 may generate an optical control signal 705 that instructs the optical system to adjust the position of the lens with respect to the component substrate and target substrate so that only electronic components in the subset are soldered. In some implementations, laser control unit 744 may generate a laser control signal 707 that instructs the laser source to adjust its with respect to the component substrate and target substrate so that only electronic components in the subset are soldered.

The present invention is not limited to the details of the above-described preferred embodiments as other variations and modifications will be apparent to those skilled in the art. The scope of the invention is defined by the appended claims and all changes and modifications as fall within the equivalence of the scope of the claims are therefore to be embraced by the invention.

The foregoing description of the specific implementations can be readily modified and/or adapted for various applications. Therefore, such adaptations and modifications are intended to be within the meaning and range of equivalents of the disclosed implementations, based on the teaching and guidance presented herein.

The breadth and scope of the present disclosure should not be limited by any of the above-described exemplary implementations, but should be defined only in accordance with the following claims and their equivalents.

What is claimed is:

1. A method for soldering using pulsed laser light, comprising:
receiving, by a processor, a set of input parameters for soldering electronic components formed on a component substrate to solder materials formed on a target substrate;
identifying, by the processor, a set of laser beam parameters for controlling the pulsed laser light based on the set of input parameters; and
controlling, by the processor, an application of the pulsed laser light to individually solder each of the electronic components and its corresponding solder material according to the set of laser beam parameters.

2. The method of claim 1, further comprising:
identifying, by the processor, a subset of the electronic components formed on the component substrate for soldering based on the set of input parameters,
wherein the controlling, by the processor, the application of the pulsed laser light to individually solder each of the electronic components and its corresponding solder material according to the set of laser beam parameters comprises:
controlling, by the processor, the application of the pulsed laser light to individually solder each electronic component of the subset of electronic components and its corresponding solder material according to the set of laser beam parameters.

3. The method of claim 1, wherein the set of input parameters comprises an indication of a subset of electronic components for soldering and an indication of the set of laser beam parameters specifying the pulsed laser light to be used to solder the subset of electronic components.

4. The method of claim 1, wherein the set of laser beam parameters comprises one or more of pulse width, laser energy, laser wavelength, laser repetition rate, or distribution profile.

5. The method of claim 4, wherein the pulse width in a range of 1 femtosecond to 1 microsecond.

6. The method of claim 4, wherein the laser energy in a range of 1 microjoule to 10 joules.

7. The method of claim 4, whereinthe laser wavelength is in a range of 200 nanometers to 1000 nanometers.

8. The method of claim 4, wherein the laser repetition rate is in a range of 1 kHz to 1 MHz.

9. The method of claim 4, wherein the distribution profile comprises one of a Gaussian distribution, a Laguerre Gaussian distribution, or a Top-hat distribution.

10. The method of claim 1, wherein the controlling, by the processor, the application of the pulsed laser light to individually solder each of the electronic components and its corresponding solder material according to the set of laser beam parameters comprises:
causing, by the processor, a laser source to output the pulsed laser light according to the set of laser beam parameters.

11. The method of claim 10, wherein the controlling, by the processor, the application of the pulsed laser light to individually solder each of the electronic components and its corresponding solder material according to the set of laser beam parameters comprises:
identifying, by the processor, a beam size to individually solder each of the electronic components and its corresponding solder material according to the set of laser beam parameters; and
positioning, by the processor, a lens of an optical system with respect to the component substrate and the target substrate to focus the pulsed laser light into the beam size onto an individual electronic component and its corresponding solder material, wherein the lens of the optical system comprises an objective lens or an f-theta lens.

12. The method of claim 1, wherein controlling, by the processor, the application of the pulsed laser light to individually solder each of the electronic components and its corresponding solder material according to the set of laser beam parameters further comprises:
controlling the pulsed laser light to only impinge on a target area that includes a single electronic component and its corresponding solder material.

13. An apparatus for laser soldering, comprising:
a laser source configured to emit pulsed laser light;
an optical system configured to focus the pulsed laser light onto a soldering area that includes an individual electronic component; and
a control unit configured to:
receive a set of input parameters for soldering electronic components formed on a component substrate to solder materials formed on a target substrate;
identify a set of laser beam parameters for controlling the pulsed laser light based on the set of input parameters; and
cause the laser source to apply the pulsed laser light to individually solder each of the electronic components and its corresponding solder material according to the set of laser beam parameters.

14. The apparatus of claim 13, wherein the control unit is further configured to:
identify a subset of the electronic components formed on the component substrate for soldering based on the set of input parameters,
wherein, to apply the pulsed laser light to individually solder each of the electronic components and its corresponding solder material according to the set of laser beam parameters, the control unit is configured to:
apply the pulsed laser light to individually solder each electronic component of the subset of electronic components and its corresponding solder material according to the set of laser beam parameters.

15. The apparatus of claim 13, wherein the set of input parameters comprises an indication of a subset of electronic components for soldering and an indication of the set of laser beam parameters.

16. The apparatus of claim 13, wherein the set of laser beam parameters comprises one or more of pulse width, laser energy, laser wavelength, laser repetition rate, or distribution profile.

17. The apparatus of claim 16, wherein:
the pulse width in a range of 1 femtosecond to 1 microsecond,
the laser energy in a range of 1 microjoule to 10 joules,
the laser wavelength is in a range of 200 nanometers to 1000 nanometers,
the laser repetition rate is in a range of 1 kHz to 1 MHz, and
the distribution profile comprises one of a Gaussian distribution, a Laguerre Gaussian distribution, or a Top-hat distribution.

18. The apparatus of claim 13, wherein, to apply the pulsed laser light to individually solder each of the electronic components and its corresponding solder material according to the set of laser beam parameters, the control unit is configured to:
identify a beam size for soldering according to the set of laser beam parameters; and
position a lens of the optical system with respect to the component substrate and the target substrate to focus the pulsed laser light into the beam size onto an individual electronic component and its corresponding solder material, wherein the lens of the optical system comprises an objective lens or an f-theta lens.

19. The apparatus of claim 18, wherein, to apply the pulsed laser light to individually solder each of the electronic components and its corresponding solder material according to the set of laser beam parameters, the control unit is configured to:
control the pulsed laser light to only impinge on a target area that includes a single electronic component and its corresponding solder material.

20. The apparatus of claim 13, further comprising:
a positioning system configured to position the component substrate with respect to the target substrate so that each of the electronic components is aligned with its corresponding solder material.
